(19) United States
(12) Patent Application Publication
(10) Pub. No.: US 2026/0058564 A1
(43) Pub. Date: Feb. 26, 2026

(54) SWITCHING CONVERTER ON RESISTANCE

(71) Applicant: TEXAS INSTRUMENTS INCORPORATED, Dallas, TX (US)

(72) Inventors: Akhila GUNDAVARAPU, Bangalore (IN); Suvadip BANERJEE, Bangalore (IN); Michael LUEDERS, Freising (DE); Suganya MANOHARAN, Bangalore (IN)

(21) Appl. No.: 18/810,959

(22) Filed: Aug. 21, 2024

(51) Int. Cl. H02M 3/335; H02M 3/00

(52) U.S. Cl. CPC H02M 3/33569; H02M 3/003

(57) ABSTRACT

A circuit includes a first transistor, a second transistor and a controller. The first transistor has a first terminal coupled to a switching terminal, a second terminal coupled to a reference terminal, and a control terminal. The first transistor is a gallium nitride transistor. The second transistor has a first terminal coupled to the switching terminal, a second terminal coupled to the reference terminal, and a control terminal. The controller has a first output coupled to the control terminal of the first transistor, and a second output coupled to the control terminal of the second transistor.

### BACKGROUND

A DC-DC converter is an electronic circuit that converts an input direct current (DC) voltage into one or more DC output voltages that are higher or lower in magnitude than the input DC voltage. A DC-DC converter that generates an output voltage lower than the input voltage is termed a buck or step-down converter. A DC-DC converter that generates an output voltage higher than the input voltage is termed a boost or step-up converter. A DC-DC converter that generates an output that is either higher or lower than the input voltage is termed a buck-boost converter.

A flyback converter is a type of switching converter that is based on the buck-boost converter, and includes a transformer in place of the inductor. The transformer includes a primary winding and a secondary winding across which voltage ratios are scaled. The transformer also provides galvanic isolation between the input and corresponding outputs. The flyback converter controls transistors and/or switches to charge and/or discharge inductors and/or capacitors to maintain a desired output voltage.

### SUMMARY

In one example, a circuit includes a first transistor, a second transistor and a controller. The first transistor has a first terminal coupled to a switching terminal, a second terminal coupled to a reference terminal, and a control terminal. The first transistor is a gallium nitride transistor. The second transistor has a first terminal coupled to the switching terminal, a second terminal coupled to the reference terminal, and a control terminal. The controller has a first output coupled to the control terminal of the first transistor, and a second output coupled to the control terminal of the second transistor.

In another example, a circuit includes a first transistor, a second transistor, and a controller. The first transistor and the second transistor are coupled in parallel between a switching terminal and a reference terminal. The first transistor is a gallium nitride transistor and has a gate. The second transistor has a gate. The controller has a first output coupled to the gate of the first transistor, and a second output coupled to the gate of the second transistor. The controller is configured to, responsive to a valley in a voltage at the switching terminal, provide a first control signal having a first state to turn off the first transistor, and a second control signal having a second state to turn on the second transistor.

In a further example, a system includes a transformer, a voltage source, and a flyback converter control circuit. The transformer includes a primary winding and a secondary winding. The primary winding has a first primary terminal and a second primary terminal. The voltage source is coupled to the first primary terminal. The flyback converter control circuit has an output coupled to the second primary terminal, and a reference terminal. The flyback converter control circuit includes a first transistor, a second transistor, and a controller. The second transistor is smaller than the first transistor. The first transistor is coupled in parallel with the second transistor between the output and the reference terminal. The first transistor is a gallium nitride transistor and has a gate. The second transistor has a gate. The controller has a first output coupled to the gate of the first transistor, and a second output coupled to the gate of the second transistor. The controller is configured to, responsive to a valley in a voltage at the output of the flyback converter control circuit, provide a first control signal having a first state to turn off the first transistor, and a second control signal having a second state to turn on the second transistor.

### BRIEF DESCRIPTION OF THE DRAWINGS

FIG. 1 is a block diagram of an example system that includes a flyback converter.

FIG. 2 is a schematic diagram of an example flyback converter control circuit that includes main and auxiliary drive transistors.

FIGS. 3 and 4 are examples of main and auxiliary drive transistor layouts in an integrated circuit.

FIG. 5 is a graph of example signals in a flyback converter that includes the flyback converter control circuit of FIG. 2.

FIG. 6 is a graph showing a comparison of example resistance in a flyback converter that includes the flyback converter control circuit of FIG. 2 versus resistance in a flyback converter using a signal drive transistor.

### DETAILED DESCRIPTION

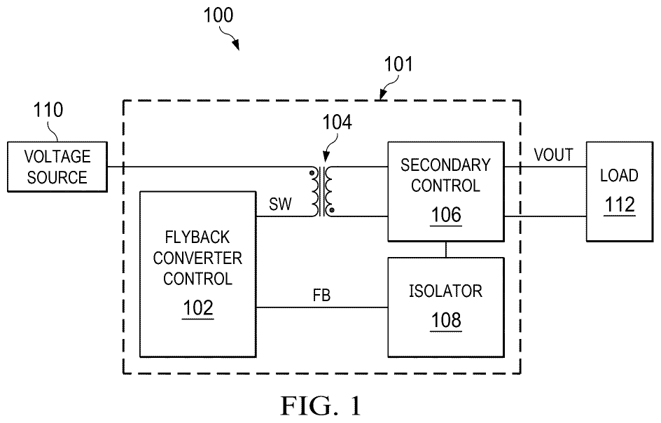

FIG. 1 is a block diagram of an example system 100. The system 100 includes a flyback converter 101 and a voltage source 110. The voltage source 110 may be a circuit that provides a DC voltage for input to the flyback converter. For example, the voltage source 110 may be an AC-DC conversion circuit with rectifiers and filtering to convert AC voltage into a DC voltage suitable for use by the flyback converter 101. The flyback converter 101 includes a flyback converter control circuit 102, a transformer 104, a secondary control circuit 106, and an isolator circuit 108. The transformer 104 includes a primary winding and a secondary winding. A first terminal of the primary winding is coupled to an output of the voltage source 110. A second terminal of the primary winding is coupled to the flyback converter control circuit 102.

The flyback converter control circuit 102 controls current flow in the primary winding of the transformer 104. For example, the flyback converter control circuit 102 may include a switch coupled between the switching output of the flyback converter control circuit 102 and a reference voltage (e.g., ground). The flyback converter control circuit 102 modulates closure of the switch to control current flow in the primary winding, and control the voltage generated on the secondary side of the transformer 104.

The secondary control circuit 106 has inputs coupled to the secondary coil of the transformer 104. The secondary control circuit 106 may include rectifiers and filtering for generating a DC voltage from the AC voltage provided by the secondary winding. An output of the secondary control circuit 106 provides output voltage VOUT to power a load circuit 112. The load circuit 112 may be any circuit powered by the flyback converter 101. The secondary control circuit 106 also includes feedback circuitry that generates a feedback signal for use by the flyback converter control circuit 102 in controlling modulation of current in the primary winding of the transformer 104.

The secondary control circuit 106 provides the feedback signal to the flyback converter control circuit 102 via the isolator circuit 108. The isolator circuit 108 may include an optical isolator, a capacitive isolator, an inductive isolator, or other type of isolation circuit. The isolator circuit 108 has an input coupled to the feedback output of the secondary control circuit 106, and an output coupled to a feedback input of the flyback converter control circuit 102. The flyback converter control circuit 102 applies the feedback signal (FB) received from the isolator circuit 108 to generate the switching signal (SW) provided at the output of the flyback converter control circuit 102 to modulate the current in the transformer 104.

In some examples of the flyback converter control circuit 102, the switch used to modulate current flow in the transformer 104 may be implemented using a gallium nitride (GaN) transistor. GaN transistors have a lower gate capacitance than silicon transistors, which enables higher switching frequencies, and allows the size of the transformer 104 to be reduced. However, when switching high voltages and/or currents, the on resistance and saturation current of GaN transistors may be degraded. For example, the on resistance of a GaN transistor may increase over time when switching high voltage and/or current, which can reduce the efficiency of the flyback converter 101. The flyback converter control circuit 102 includes circuitry that reduces the degradation of switching transistor on resistance to improve the efficiency of the flyback converter 101.

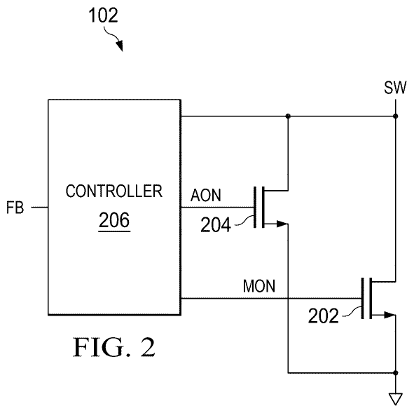

FIG. 2 is a schematic diagram of an example flyback converter control circuit 102. The flyback converter control circuit 102 includes a main transistor 202, an auxiliary transistor 204, and a controller 206. The main transistor 202 may be an n-channel GaN transistor. The auxiliary transistor 204 may be an n-channel GaN transistor or an n-channel field effect transistor (N-FET). In one example of the flyback converter control circuit 102, the main transistor 202 and the auxiliary transistor 204 are provided on a first integrated circuit, and the controller 206 is provided on a second integrated circuit. In another example of the of the flyback converter control circuit 102, the main transistor 202 is provided on a first integrated circuit, and the controller 206 and the auxiliary transistor 204 are provided on a second integrated circuit. The main transistor 202 and the auxiliary transistor 204 are coupled in parallel between the output (or switching terminal) SW of the flyback converter control circuit 102 and a reference terminal (e.g., a ground terminal) of the flyback converter control circuit 102. The main transistor 202 has a first terminal (e.g., drain) coupled to the output (or switching terminal) SW of the flyback converter control circuit 102, a second terminal (e.g., source) coupled to the reference terminal of the flyback converter control circuit 102, and a control terminal (e.g., gate) coupled to the controller 206. The auxiliary transistor 204 has a first terminal (e.g., drain) coupled to the first terminal of the main transistor 202, a second terminal (e.g., source) coupled to the second terminal of the main transistor 202, and a control terminal (e.g., gate) coupled to the controller 206. The auxiliary transistor 204 may be smaller (e.g., have a smaller channel width) than the main transistor 202. For example, the auxiliary transistor 204 may be one quarter the size of the main transistor 202. Accordingly, the main transistor 202 may be larger than the auxiliary transistor 204.

The controller 206 controls turn on and turn off of the main transistor 202 and auxiliary transistor 204. The controller 206 has a first input coupled to the feedback input of the flyback converter control circuit 102 for receipt of the FB signal, and a second input coupled to the primary winding of the transformer 104 via the output of the flyback converter control circuit 102. The controller 206 has a first output coupled to the control terminal of the auxiliary transistor 204, and a second output coupled to the control terminal of the main transistor 202. The controller 206 provides a control signal AON at the first output for turning the auxiliary transistor 204 on or off, and provides a control signal MON at the second output for turning the main transistor 202 on or off.

The controller 206 may provide quasi-resonant control of the main transistor 202 and the auxiliary transistor 204. The controller 206 may turn on the main transistor 202 and the auxiliary transistor 204 responsive to detection of a valley in the voltage at the output of the flyback converter control circuit 102 (e.g., the drain-to-source voltage of the main transistor 202 and auxiliary transistor 204). The valley is a minima (a negative half-cycle) in oscillation of voltage at the output of the flyback converter control circuit 102 occurring when the main transistor 202 and auxiliary transistor 204 have been turned off, and after the secondary winding of the transformer 104 has discharged. The controller 206 may include circuitry to detect a valley in the voltage at the output of the flyback converter control circuit 102.

The controller 206 turns on the main transistor 202 and the auxiliary transistor 204 responsive to detection of a valley, by first turning on the auxiliary transistor 204, and thereafter turning on the main transistor 202. By turning on the auxiliary transistor 204 first, the auxiliary transistor 204 is subjected to the stress of switching a high voltage (e.g., 60 volts, 250 volts, etc.) and the main transistor 202 is relieved from the stress of switching the high voltage. Because the main transistor 202 is not subjected to the stress of switching a high voltage provided across the main transistor 202 and the auxiliary transistor 204 when the auxiliary transistor 204 is turned on, the increase in the on resistance of the main transistor 202 caused by switching is reduced or eliminated. Accordingly, the flyback converter control circuit 102 can provide improved efficiency relative to use of a single GaN transistor.

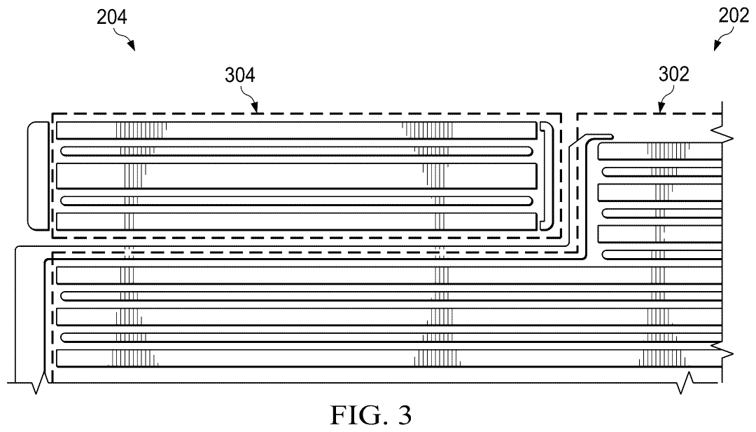

FIG. 3 shows the main transistor 202 and the auxiliary transistor 204 on an integrated circuit. Each of the transistors includes a gate ring for isolation, a first gate ring 302 surrounds the main transistor 202, and a second gate ring 304 surrounds the auxiliary transistor 204. The gate ring around the auxiliary transistor 204 significantly increases the size of the flyback converter control circuit 102, which increases the cost of the flyback converter control circuit 102.

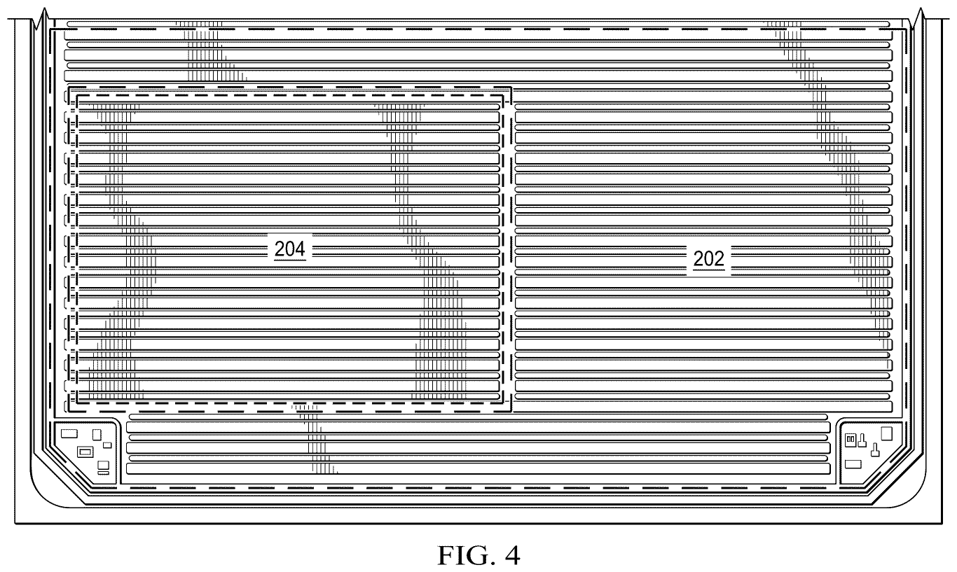

FIG. 4 shows the main transistor 202 and the auxiliary transistor 204 on an integrated circuit, where the gate ring of the main transistor 202 is used as an isolation for auxiliary transistor 204. In the example of FIG. 4, the auxiliary transistor 204 is placed within the gate ring of the main transistor 202, and the gate ring of the main transistor 202 isolates the auxiliary transistor 204. Accordingly, in FIG. 4, the lack of a separate gate ring around the auxiliary transistor 204 significantly reduces the size of the flyback converter control circuit 102 relative to the implementation of FIG. 3, which reduces the circuit area and cost of the flyback converter control circuit 102, relative to use of the implementation of FIG. 3.

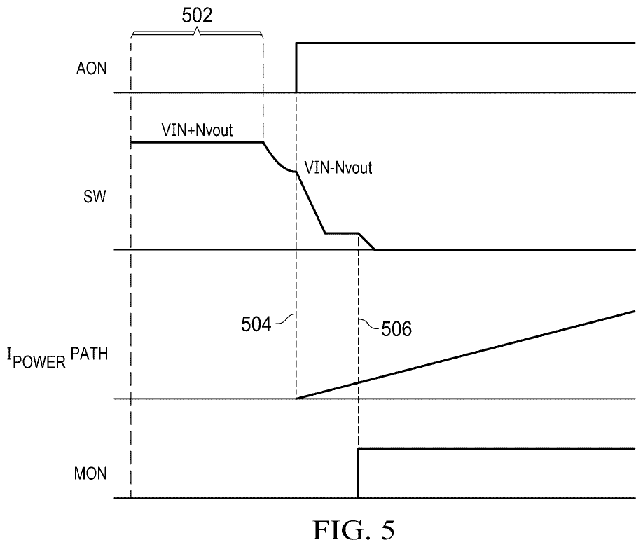

FIG. 5 is a graph of example signals in the flyback converter 101. FIG. 5 shows the transistor control signals AON and MON, the voltage SW at the output of the flyback converter 101, and the current I_{POWER} flowing in the primary winding of the transformer 104. In the time interval 502, the main transistor 202 and the auxiliary transistor 204 are off, and the transformer 104 is discharging. At the end of the time interval 502, the transformer 104 is discharged, and the voltage at the output of the flyback converter 101 begins to oscillate. At time 504, the voltage at the output of the flyback converter 101 is in a valley. The controller 206 detects the valley, and changes the state of AON to turn on the auxiliary transistor 204, while the main transistor 202 remains off. With the auxiliary transistor 204 on, the current flowing in the primary winding of the transformer 104 increases, and the voltage at the output of the flyback converter 101 decreases. At time 506, the controller 206 is monitoring the slew of the voltage at the output of the flyback converter 101 and detects that the voltage is not changing. Responsive to the unchanging voltage, the controller 206 changes the state of MON to turn on the main transistor 202, while the auxiliary transistor 204 remains on. With the main transistor 202 turned on, the current flowing in the primary winding of the transformer 104 continues to increase, and the voltage at the output of the flyback converter 101 continues to decrease. Because the voltage across the main transistor 202 is relatively low at time 506, the switching stress to which the main transistor 202 is subjected is relatively low, and the degradation of the on resistance of the main transistor 202 due to switching is reduced.

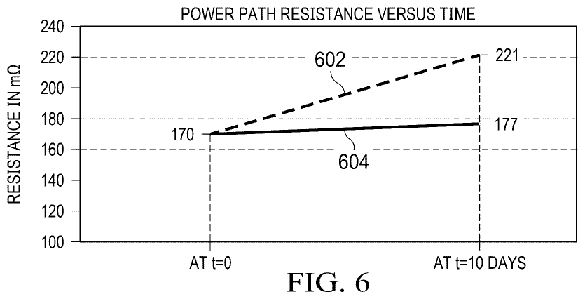

FIG. 6 is a graph showing a comparison of example resistance of the switch in the flyback converter 101. The curve 602 shows the resistance where the switch includes a single GaN transistor. The curve 604 shows the resistance of the switch in the flyback converter 101, which includes the main transistor 202 and the auxiliary transistor 204. In both cases (the single transistor and the flyback converter 101), the initial switch resistance (resistance at time t=0), is about 170 milliohms. After about 10 days of switching, the resistance of the switch including the single GaN transistor has increased to about 221 milliohms (a 30% increase in resistance), while the resistance of the switch in the flyback converter 101 has increased to only about 177 milliohms (a 4% increase in resistance). Accordingly, in this example, the change in on resistance of the flyback converter 101 is about one-seventh the change in resistance of the switch with the single GaN transistor. The lower on resistance of the flyback converter 101 increases the efficiency of the flyback converter 101.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, in some cases, other transistors (or equivalent devices) may be used instead with little or no change to the remaining circuitry. For example, a field effect transistor (“FET”) (such as an n-channel FET (NFET) (n-type transistor) or a p-channel FET (PFET) ) (p-type transistor)), a bipolar junction transistor (BJT—e.g., NPN transistor or PNP transistor), an insulated gate bipolar transistor (IGBT), and/or a junction field effect transistor (JFET) may, in some cases, be used in place of or in conjunction with some of the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input (or transistor control terminal) is the gate, and the current terminals are the drain and source. In the context of a BJT, the control input is the base, and the current terminals are the collector and emitter.

References herein to a FET being “ON” means that the conduction channel of the FET is present and drain current may flow through the FET. References herein to a FET being “OFF” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. A circuit comprising:
a first transistor having a first terminal coupled to a switching terminal, a second terminal coupled to a reference terminal, and a control terminal, where the first transistor is a gallium nitride (GaN) transistor;
a second transistor having a first terminal coupled to the switching terminal, a second terminal coupled to the reference terminal, and a control terminal; and
a controller having a first output coupled to the control terminal of the first transistor, and a second output coupled to the control terminal of the second transistor.

2. The circuit of claim 1, wherein the second transistor is a GaN transistor.

3. The circuit of claim 1, wherein the second transistor is a silicon transistor.

4. The circuit of claim 1, wherein the first transistor and the second transistor are on a first die, and the controller is on a second die.

5. The circuit of claim 4, wherein the first transistor includes a gate ring around the first transistor, and the second transistor is within the gate ring.

6. The circuit of claim 4, wherein the first transistor includes a first gate ring, and the second transistor includes a second gate ring.

7. The circuit of claim 1, wherein the first transistor is larger than the second transistor.

8. The circuit of claim 1, wherein the controller is configured to:
provide a first control signal at the first output, and provide a second control signal at the second output; and
responsive to a valley in a voltage at the switching terminal, change a state of the second control signal to turn on the second transistor, and provide the first control signal with a state to turn off the first transistor.

9. The circuit of claim 8, wherein the controller is configured to change the state of the first control signal responsive to the voltage at the switching terminal not changing, and provide the second control signal with a state to turn on the second transistor.

10. A circuit comprising:
a first transistor and a second transistor coupled in parallel on a same die between a switching terminal and a reference terminal, the first transistor being a gallium nitride transistor having a gate, and the second transistor having a gate; and
a controller having a first output coupled to the gate of the first transistor, and a second output coupled to the gate of the second transistor, the controller configured to, responsive to a valley in a voltage at the switching terminal, provide a first control signal having a first state to turn off the first transistor, and a second control signal having a second state to turn on the second transistor.

11. The circuit of claim 10, wherein the controller is configured to, responsive to the voltage at the switching terminal being less than a threshold and the second control signal having the second state, provide the first control signal having the second state to turn on the first transistor.

12. The circuit of claim 10, wherein the second transistor is a GaN transistor.

13. The circuit of claim 10, wherein the first transistor and the second transistor are on a first die, and the controller is on a second die.

14. The circuit of claim 13, wherein the first transistor includes a gate ring around the first transistor, and the second transistor is within the gate ring.

15. The circuit of claim 13, wherein the first transistor includes a first gate ring, and the second transistor includes a second gate ring.

16. The circuit of claim 10, wherein the first transistor is larger than the second transistor.

17. A system comprising:
a transformer including a primary winding and a secondary winding, the primary winding having a first primary terminal and a second primary terminal;
a voltage source coupled to the first primary terminal;
a flyback converter control circuit having an output coupled to the second primary terminal, and a reference terminal, the flyback converter control circuit including:
a first transistor and a second transistor that is smaller than the first transistor coupled in parallel between the output and the reference terminal, the first transistor being a gallium nitride transistor having a gate, and the second transistor having a gate; and
a controller having a first output coupled to the gate of the first transistor, and a second output coupled to the gate of the second transistor, the controller configured to, responsive to a valley in a voltage at the output of the flyback converter control circuit, provide a first control signal having a first state to turn off the first transistor, and a second control signal having a second state to turn on the second transistor.

18. The system of claim 17, wherein the controller is configured to, responsive to the voltage at the output being less than a threshold and the second control signal having the second state, provide the first control signal having the second state to turn on the first transistor.

19. The system of claim 17, wherein flyback converter control circuit is part of an integrated circuit, and the first transistor includes a gate ring around the first transistor, and the second transistor is within the gate ring.

20. The system of claim 17, wherein flyback converter control circuit is part of an integrated circuit, and the first transistor includes a first gate ring around the first transistor, and the second transistor includes a second gate ring.
